(19) United States
(12) Patent Application Publication
(10) Pub. No.: US 2022/0356374 A1
(43) Pub. Date: Nov. 10, 2022

(54) COMPOSITION AND ARTICLE COMPRISING THE SAME

(71) Applicant: 3M INNOVATIVE PROPERTIES COMPANY, St. Paul, MN (US)

(72) Inventors: Anna M. Clausen, Minneapolis, MN (US); Jeffrey A. Peterson, Hugo, MN (US); Maria A. Appeaning, St. Paul, MN (US); Christopher P. Gerlach, Woodbury, MN (US)

(21) Appl. No.: 17/433,969

(22) PCT Filed: Mar. 25, 2020
(86) PCT No.: PCT/IB2020/052805

§ 371 Date: Aug. 25, 2021

Related U.S. Application Data
(60) Provisional application No. 62/825,961, filed on Mar. 29, 2019.

(51) Int. Cl. C09J 7/20; C09J 7/25

(52) U.S. Cl. CPC C09J 7/201; C09J 7/255; C09J 2467/006; C09J 2483/003; C09J 2483/005; C09J 2475/003

(57) ABSTRACT

Uncured aqueous composition comprising a blend of (a) a sulfonated polyester, (b) at least one of a self-crosslinking acrylic or a self-crosslinking polyurethane binder, and (c) melamine-formaldehyde crosslinker, wherein the uncured aqueous composition has a free-formaldehyde content not greater than 0.04 part per million formaldehyde as determined by the Formaldehyde Test, and cured composition thereof. Compositions described herein are useful, for example, for making primed film for release liners applications.

### BACKGROUND

Crosslinked coatings are often used to adhesively prime polymer films (i.e., to make the surface more adhesively receptive to a subsequent coating). There is need in the industry to continue to improve the environmental friendliness of coating processes.

One approach to improving the environmental friendliness of coating processes has been to move away from the use of organic solvent-based coatings, and toward increased use of aqueous, or water-based, coatings. Another approach has been to reduce the free formaldehyde content during the coating process and in the finished coatings. These two approaches tend to provide lower levels of volatile organic compounds (VOCs) released to the environment.

Desirably, a primer coating contains little, if any, free formaldehyde once the coating is dried. Some crosslinkers used in primer coatings for improved adhesion of subsequent coatings contain formaldehyde and other VOCs that are liberated as the coating is mixed or coated. Preferably, primer coatings have good adhesion to the substrate being primed (e.g., a polyester or polypropylene film). Primer coatings preferably have good adhesion to subsequent coatings (e.g., release coatings or adhesives). In addition, since not all subsequent coatings can be applied out of aqueous solutions or dispersions, primer coatings preferably have resistance to subsequent solvent-based processing, including the application of a release coating or adhesive out of an organic solvent.

One common class of crosslinkers used in coating formulations is melamine-formaldehyde (MF) resins. These resins have been used because of their performance compared to other well-known crosslinking options.

There is a need for new methods for using melamine-formaldehyde crosslinkers that reduce or prevent the release of free formaldehyde during and after processing. There is also a need for new methods that produce good crosslinked coatings at lower levels of the melamine-formaldehyde crosslinker.

### SUMMARY

In one aspect the present disclosure describes an uncured aqueous composition (i.e., a composition where at least 50 percent by weight of liquid present is water) comprising a blend of (a) a sulfonated polyester, (b) at least one of a self-crosslinking acrylic or a self-crosslinking polyurethane binder, and (c) melamine-formaldehyde crosslinker, wherein the uncured aqueous composition has a free-formaldehyde content not greater than 0.04 (in some embodiments, not greater than 0.03, 0.025, 0.02, or even not greater than 0.01) part per million formaldehyde as determined by the Formaldehyde Test (as described in the Examples).

In another aspect, the present disclosure describes an article comprising, in order:
a first polymeric film having first and second, opposed major surfaces,
a first layer having first and second, opposed major surfaces on the first major surface of the first polymeric layer, the first layer provided by curing a first uncured aqueous composition comprising a blend of (a) a sulfonated polyester, (b) at least one of a self-crosslinking acrylic or a self-crosslinking polyurethane binder, and (c) melamine-formaldehyde crosslinker, wherein the uncured aqueous composition has a free-formaldehyde content not greater than 0.04 (in some embodiments, not greater than 0.03, 0.025, 0.02, or even not greater than 0.01) part per million formaldehyde as determined by the Formaldehyde Test (described in the Examples); and
a first release layer having first and second, opposed major surfaces on the first major surface of the first layer.

Compositions described herein are useful, for example, for making primed film for release liners applications.

### BRIEF DESCRIPTION OF THE DRAWINGS

The FIGURE is a schematic of an exemplary article described herein.

### DETAILED DESCRIPTION

The present disclosure describes an uncured aqueous composition comprising a blend of (a) a sulfonated polyester, (b) at least one of a self-crosslinking acrylic or a self-crosslinking polyurethane binder, and (c) melamine-formaldehyde crosslinker, wherein the uncured aqueous composition has a free-formaldehyde content not greater than 0.04 (in some embodiments, not greater than 0.03, 0.025, 0.02, or even not greater than 0.01) part per million formaldehyde as determined by the Formaldehyde Test (as described in the Examples). That is, free-formaldehyde refers to outgassing formaldehyde as detected by the Formaldehyde Test.

In some embodiments, the sulfonated polyester has a glass transition temperature not greater than 75 (in some embodiments, not greater than 70, 65, 60, 55, 50, 45, 40, 35, 30, 25, 20, 15, 10, 5, 0, −5; in some embodiments, in a range from −10 to 75, 0 to 60, 10 to 60, 20 to 60, 25 to 60, or even, 45 to 55) ° C.

In some embodiments, the sulfonated polyester comprises an oxyalkylene (OR) having a carbon chain length of at least 2 (in some embodiments, at least 3, 4, 5, 6, 7 or even at least 8; in some embodiments, up to 20, 21, 22, 23, 24, 25, 26, 27, 28, 29, 30, 31, 32, 33, 34, 35 or even up to 36) carbon atoms.

In some embodiments, at least one of the sulfonated polyesters have the formula:

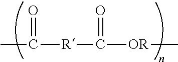

wherein n is at least 10 (in some embodiments, at least 20, 30, 40 50 100, 200, 250, 500, 1000, 5000, 8000, or even 10000), and wherein at least some R′ comprise arylenesulfonate (e.g., at least one alkali arylenesulfonate). In some embodiments, the arylenesulfonate comprises at least one of a phenylenesulfonate, an isophthalylene-5-sulfonate, a terephthalylene-sulfonate, or a phthalylene-sulfonate. In some embodiments, the arylenesulfonate comprises at least one of lithium arylenesulfonate, sodium arylenesulfonate, potassium arylenesulfonate, calcium arylenesulfonate, beryllium arylenesulfonate, a zinc arylenesulfonate, a zirconium arylenesulfonate, a vanadium arylenesulfonate, copper arylenesulfonate, or aluminum arylenesulfonate.

Exemplary sulfonated polyesters are available, for example, under the trade designations “SKYBON” from SKCs America Inc., Irvine, Calif., and “EASTEK” from Eastman Chemical Company, Kingsport, Tenn. Exemplary sulfonated polyethylene naphthalate can be synthesis ed by techniques known in the art such as from dimethyl naphthalate, a dimethyl sodium 5-sulfoisophthalate, and ethylene glycol as described in Examples 3 and 4.

In some embodiments, the sulfonated polyester is present in a range from 0.1 to 40 (in some embodiments, in a range from 10 to 70 (in some embodiments, in a range from 10 to 50, or even 25 to 50) weight percent, based the total solids content of the uncured aqueous composition.

Self-crosslinking acrylics refer to acrylic latexes having functional groups that can react and crosslink with each other (i.e., capable of crosslinking without the addition of an additional chemical crosslinking agent). Exemplary self-crosslinking acrylics are available, for example, under the trade designations “AC 2314” and “AC 2360” from Alberdingk Boley Inc, Greensboro, N.C.

In some embodiments, the self-crosslinking acrylic is present in a range from 10 to 80 (in some embodiments, in a range from 10 to 70, 25 to 70, 30 to 70, 35 to 70, or even 40 to 70) weight percent, based the total solid content of the uncured aqueous composition.

Self-crosslinking polyurethanes refer to polyurethane latexes comprising functional groups that can react and crosslink with each other (i.e., capable of crosslinking without an additional chemical crosslinking agent). Exemplary self-crosslinking polyurethanes are available, for example, under the trade designation “TURBOSET ULTRA PRO” and “TURBOSET 2027” from Lubrizol, Wickliffe, Ohio.

In some embodiments, the self-crosslinking polyurethane binder is present in a range from 10 to 80 (in some embodiments, in a range from 10 to 70, 25 to 70, 30 to 70, 35 to 70, or even 40 to 70) weight percent, based the total solid content of the uncured aqueous composition.

Melamine-formaldehyde crosslinker refers to water dispersible partially alkylated melamine-formaldehyde resins. In some embodiments, the melamine-formaldehyde crosslinker comprises a partially alkoxymethylated melamine formaldehyde resin. An exemplary water dispersible partially alkylated melamine-formaldehyde resin is available, for example, under the trade designation “CYMEL 327” from Allnex Corporation, Alpharetta, Ga.

In some embodiments, the melamine-formaldehyde crosslinker is present in a range from 1 to 15 (in some embodiments, in a range from 2 to 11) weight percent, based the total solids content of the uncured aqueous composition.

The raw materials for making the uncured aqueous composition by conventional techniques known in the art such as die coating, gravure coating, Mayer rod coating, air knife coating, spin coating, and dip coating.

Uncured aqueous composition described herein can be cured by conventional techniques known in the art such as thermal curing.

Compositions described herein are useful, for example, for making articles such as adhesion promotors to silicone release coatings.
An exemplary article comprises, in order:
a first polymeric film having first and second, opposed major surfaces;
a first layer having first and second, opposed major surfaces on the first major surface of the first polymeric layer, the first layer comprising a first cured aqueous composition provided by curing an uncured aqueous composition described herein;
a first release layer (e.g., silicone release layer) having first and second, opposed major surfaces on the first major surface of the first layer;
an optional first optically clear adhesive layer having first and second, opposed major surfaces on the first major surface of the first release layer; and
an optional second polymeric film (e.g., a polyester film) having first and second, opposed major surfaces on the first major surface of the first optically clear layer;
an optional second layer having first and second, opposed major surfaces on the second major surface of the first polymeric film;
an optional second release layer (e.g., a silicone release layer) having first and second, opposed major surfaces on the second major surface of the second layer;
an optional second optically clear adhesive layer having first and second, opposed major surfaces on the second major surface of the second release layer; and
optional third polymeric film (e.g. one of a polyester, or polypropylene, or polyethylene film) having first and second, opposed major surfaces on the second major surface of the second release layer.

In some embodiments, the first or optional second optically clear adhesive layer comprises a (meth)acrylate copolymer having pendant (meth)acryloyl groups and optionally pendant hydroxyl groups (e.g., compounded with a free-radical generating initiator), wherein the (meth)acrylate copolymer has a weight average molecular weight of 50,000 to 600,000 Daltons and an average molecular weight between (meth)acryloyl groups equal to at least 16,000 Daltons. In some embodiments, the first or optional second optically clear adhesive layer has a thickness in a range from 100 to 250 (in some embodiments, in a range from 125 to 200) micrometers.

In some embodiments of articles described herein if the first optically clear adhesive layer is peeled from the first major surface of the first release layer, the first major surface of the first release layer exhibits a haze not greater than 10% (measured using a haze meter obtained under the trade designation “HAZE-GARD PLUS” from BYK-Gardner, Columbia, Md.). In some embodiments of articles described herein if the optional second optically clear adhesive layer is peeled from the second major surface of the optional second release layer, the second major surface of the second release layer exhibits a haze not greater than 10% (measured using a haze meter obtained under the trade designation “HAZE-GARD PLUS” from BYK-Gardner, Columbia, Md.).

In some embodiments of articles described herein, if the first or second optically clear adhesive layer is peeled from the first major surface of the respective release layer, the first major surface of the release layer has a surface roughness, Rₐ, not greater than 0.15 (in some embodiments, not greater than 0.1, or even not greater than 0.05) micrometer (as described in the Examples). In some embodiments of articles described herein, if the optional second optically clear adhesive layer is peeled from the second major surface of the respective release layer, the second major surface of the release layer has a surface roughness, Rₐ, not greater than 0.15 (in some embodiments, not greater than 0.1, or even not greater than 0.05) micrometer (as described in the Examples).

In some embodiments, the optional second layer comprises a cured aqueous composition described herein provided by curing an uncured aqueous composition described herein, by curing an uncured aqueous composition described in copending application having U.S. Ser. No. ______ (Attorney Docket No. 80972US002), filed the same date as the instant application, the disclosure of which is incorporated herein by reference. In some embodiments, the optional second layer comprises a corona treatment, for example, of a polyethylene terephthalate (PET) film.

In some embodiments of articles described herein, the first or optional second layer has a thickness in a range from 0.05 to 0.5 (in some embodiments, in a range from 0.01 to 0.5) micrometer.

In some embodiments of articles described herein, the first, optional second, or optional third polymeric film has a thickness in a range from 25 to 125 (in some embodiments, in a range from 50 to 75) micrometers. In some embodiments, the first, optional second, or optional third polymeric film is independently one of a polyester, polypropylene, or polyethylene film.

In some embodiments of articles described herein, the first or optional second release layer has a thickness of at least 0.02 (in some embodiments, in a range from 0.025 to 0.5, or even 0.05 to 0.5) micrometer.

In some embodiments, articles described herein have a thickness in a range from 200 to 400 micrometers.

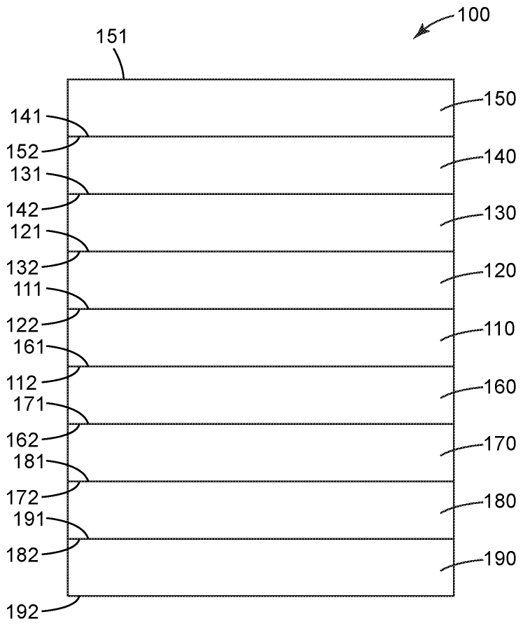

Referring to FIG. 1, exemplary article described herein 100 is shown. Article 100 comprises first polymeric film 110 having first and second, opposed major surfaces 111, 112, first layer 120 having first and second, opposed major surfaces 121, 122, first release layer 130 having first and second, opposed major surfaces 131, 131 optional first optically clear adhesive layer 140 having first and second, opposed major surfaces 141, 142, optional second polymeric film 150 having first and second major surfaces 151, 152, optional second layer 160 having first and second major surfaces 161, 162, optional second release layer 170 having first and second, opposed major surfaces 171, 172, optional second optically clear adhesive layer 180 having first and second, opposed major surfaces 181, 182, and optional third polymeric film 190 having first and second major surfaces 191, 192. First layer 120 provided by curing an uncured aqueous composition described herein.

Compositions described herein are useful, for example, for making primed film for release liners applications.

### EXEMPLARY EMBODIMENTS

1A. An uncured aqueous composition comprising a blend of (a) a sulfonated polyester, (b) at least one of a self-crosslinking acrylic or a self-crosslinking polyurethane binder, and (c) melamine-formaldehyde crosslinker, wherein the uncured aqueous composition has a free-formaldehyde content not greater than

0.04 (in some embodiments, not greater than 0.03, 0.025, 0.02, or even not greater than 0.01) part per million formaldehyde as determined by the Formaldehyde Test.

2A. The uncured aqueous composition of Exemplary Embodiment 1A, wherein the sulfonated polyester comprises an oxyalkylene (OR) having a carbon chain length of at least 2 (in some embodiments, at least 3, 4, 5, 6, 7 or even at least 8; in some embodiments, up to 20, 21, 22, 23, 24, 25, 26, 27, 28, 29, 30, 31, 32, 33, 34, 35 or even up to 36) carbon atoms.

3A. The uncured aqueous composition of either Exemplary Embodiment 1A or 2A, wherein the sulfonated polyester has a glass transition temperature not greater than 75 (in some embodiments, not greater than 70, 65, 60, 55, 50, 45, 40, 35, 30, 25, 20, 15, 10, 5, 0, -5; in some embodiments, in a range from −10 to 75, 0 to 60, 10 to 60, 20 to 60, 25 to 60, or even, 45 to 55) ° C.

4A. The uncured aqueous composition of any preceding A Exemplary Embodiment, wherein the sulfonated polyester has the formula:

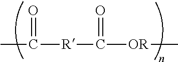

wherein n is at least 10 (in some embodiments, at least 20, 30, 40 50 100, 200, 250, 500, 1000, 5000, 8000, or even 10000), and wherein at least some R′ comprise arylenesulfonate (e.g., at least one alkali arylenesulfonate).

5A. The uncured aqueous composition of Exemplary Embodiment 4A, wherein the arylenesulfonate comprises at least one of a phenylenesulfonate, an isophthalylene-5-sulfonate, a terephthalylene-sulfonate, or a phthalylene-sulfonate.

6A. The uncured aqueous composition of either Exemplary Embodiment 4A or 5A, the arylenesulfonate comprises at least one of lithium arylenesulfonate, sodium arylenesulfonate, potassium arylenesulfonate, calcium arylenesulfonate, beryllium arylenesulfonate, a zinc arylenesulfonate, a zirconium arylenesulfonate, a vanadium arylenesulfonate, copper arylenesulfonate, or aluminum arylenesulfonate.

7A. The uncured aqueous composition of any preceding A Exemplary Embodiment, wherein the sulfonated polyester is present in a range from 10 to 70 (in some embodiments, in a range from 10 to 50, or even 25 to 50) weight percent, based the total solid content of the uncured aqueous composition.

8A. The uncured aqueous composition of any preceding A Exemplary Embodiment, wherein the self-crosslinking acrylic is present and contains both carbonyl and hydrazone functional group that can react and crosslink with each other.

9A. The uncured aqueous composition of any preceding A Exemplary Embodiment, wherein the self-crosslinking acrylic is present in a range from 10 to 80 (in some embodiments, in a range from 10 to 70, 25 to 70, 30 to 70, 35 to 70, or even 40 to 70) weight percent, based the total solid content of the uncured aqueous composition.

10A. The uncured aqueous composition of any preceding A Exemplary Embodiment, wherein the self-crosslinking polyurethane is present and contains both carbonyl and hydrazone functional group that can react and crosslink with each other.

11A. The uncured aqueous composition of any preceding A Exemplary Embodiment, wherein the self-crosslinking polyurethane binder is present in a range from 10 to 80 (in some embodiments, in a range from 10 to 70, 25 to 70, 30 to 70, 35 to 70, or even 40 to 70) weight percent, based the total solid content of the uncured aqueous composition.

12A. The uncured aqueous composition of any preceding A Exemplary Embodiment, wherein the melamine-formaldehyde crosslinker comprises a partially alkoxymethylated melamine formaldehyde resin.

13A. The uncured aqueous composition of any preceding A Exemplary Embodiment, wherein the melamine-formaldehyde crosslinker is present in a range from 1 to 15 (in some embodiments, in a range from 2 to 11) weight percent, based the total solid content of the uncured aqueous composition.

1B. The uncured aqueous composition of any preceding A Exemplary Embodiment that is cured.

1C. An article comprising, in order:
a first polymeric film having first and second, opposed major surfaces,
a first layer having first and second, opposed major surfaces provided by curing an uncured aqueous composition comprising a blend of (a) a sulfonated polyester, (b) at least one of a self-crosslinking acrylic or a self-crosslinking polyurethane binder, and (c) melamine-formaldehyde crosslinker, wherein the uncured aqueous composition has a free-formaldehyde content not greater than 0.04 (in some embodiments, not greater than 0.03, 0.025, 0.02, or even not greater than 0.01) part per million formaldehyde as determined by the Formaldehyde Test; and
a first release layer having first and second, opposed major surfaces.

2C. The article of Exemplary Embodiment 1C, wherein the sulfonated polyester comprises an oxyalkylene (OR) having a carbon chain length of at least 2 (in some embodiments, at least 3, 4, 5, 6, 7 or even at least 8; in some embodiments, up to 20, 21, 22, 23, 24, 25, 26, 27, 28, 29, 30, 31, 32, 33, 34, 35 or even up to 36) carbon atoms.

3C. The article of either Exemplary Embodiment 1C or 2C, wherein the sulfonated polyester has a glass transition temperature not greater than 75 (in some embodiments, not greater than 70, 65, 60, 55, 50, 45, 40, 35, 30, 25, 20, 15, 10, 5, 0, −5; in some embodiments, in a range from −10 to 75, 0 to 60, 10 to 60, 20 to 60, 25 to 60, or even, 45 to 55) ° C.

4C. The article of any preceding C Exemplary Embodiment, wherein the sulfonated polyester has the formula:

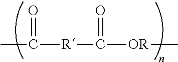

wherein n is at least 10 (in some embodiments, at least 20, 30, 40 50 100, 200, 250, 500, 1000, 5000, 8000, or even 10000), and wherein at least some R′ comprise arylenesulfonate (e.g., at least one alkali arylenesulfonate).

5C. The article of Exemplary Embodiment 4C, wherein the arylenesulfonate comprises at least one of a phenylenesulfonate, an isophthalylene-5-sulfonate, a terephthalylene-sulfonate, or a phthalylene-sulfonate.

6C. The article of either Exemplary Embodiment 4C or 5C, the arylenesulfonate comprises at least one of lithium arylenesulfonate, sodium arylenesulfonate, potassium arylenesulfonate, calcium arylenesulfonate, beryllium arylenesulfonate, a zinc arylenesulfonate, a zirconium arylenesulfonate, a vanadium arylenesulfonate, copper arylenesulfonate, or aluminum arylenesulfonate.

7C. The article of any preceding C Exemplary Embodiment, wherein the sulfonated polyester is present in a range from 10 to 70 (in some embodiments, in a range from 10 to 50, or even 25 to 50) weight percent, based the total solid content of the uncured aqueous composition.

8C. The article of any preceding C Exemplary Embodiment, wherein the self-crosslinking acrylic is present and contains both carbonyl and hydrazone functional group that can react and crosslink with each other.

9C. The article of any preceding C Exemplary Embodiment, wherein the self-crosslinking acrylic is present in a range from 10 to 80 (in some embodiments, in a range from 10 to 70, 25 to 70, 30 to 70, 35 to 70, or even 40 to 70) weight percent, based the total solid content of the uncured aqueous composition.

10C. The article of any preceding C Exemplary Embodiment, wherein the self-crosslinking polyurethane is present and contains both carbonyl and hydrazone functional group that can react and crosslink with each other.

11C. The article of any preceding C Exemplary Embodiment, wherein the self-crosslinking polyurethane binder is present in a range from 10 to 80 (in some embodiments, in a range from 10 to 70, 25 to 70, 30 to 70, 35 to 70, or even 40 to 70) solids content percent, based the total solid content of the uncured aqueous composition.

12C. The article of any preceding C Exemplary Embodiment, wherein the melamine-formaldehyde crosslinker a partially alkoxymethylated melamine formaldehyde resin.

13C. The article of any preceding C Exemplary Embodiment, wherein the melamine-formaldehyde crosslinker is present in a range from 1 to 15 (in some embodiments, in a range from 2 to 11) weight percent, based the total solid content of the uncured aqueous composition.

14C. The article of any preceding C Exemplary Embodiment, wherein the first release layer is a silicone release layer.

15C. The article of any preceding Exemplary Embodiment, further comprising a first optically clear adhesive layer having first and second, opposed major surfaces on the first major surface of the silicone release layer.

16C. The article of Exemplary Embodiment 13C, wherein the first optically clear adhesive layer comprises a (meth)acrylate copolymer having pendant (meth)acryloyl groups and optionally pendant hydroxyl groups (e.g., compounded with a free-radical generating initiator), wherein the (meth)acrylate copolymer has a weight average molecular weight of 50,000 to 600,000 Daltons and an average molecular weight between (meth)acryloyl groups equal to at least 16,000 Daltons.

17C. The article of any either Exemplary Embodiment 15C or 16C, wherein the first optically clear adhesive layer has a thickness in a range from 100 to 250 (in some embodiments, in a range from 125 to 200) micrometers.

18C. The article of any of Exemplary Embodiment 15C to 17C, wherein if the first optically clear adhesive layer is peeled from the first major surface of the first release layer, the first major surface of the first release layer exhibits a haze not greater than 10% (measured using a haze meter obtained under the trade designation “HAZE-GARD PLUS” from BYK-Gardner, Columbia, Md.).

19C. The article of any of Exemplary Embodiment 15C to 18C, wherein if the first optically clear adhesive layer is peeled from the first major surface of the first release layer, the first major surface of the first release layer has a surface roughness, Rₐ, not greater than 0.15 (in some embodiments, not greater than 0.1, or even not greater than 0.05) micrometer (as described in the Examples).

20C. The article of any of Exemplary Embodiments 15C to 19C, further comprising a second polymeric film having first and second, opposed major surfaces on the first major surface of the first optically clear layer, wherein the article comprises in order, the first polymeric film, the layer, the first release layer, the first optically clear layer, and the second polymeric film.

21C. The article of Exemplary Embodiment 20C, wherein the second polymeric film is one of a polyester, polypropylene, or polyethylene film.

22C. The article of any preceding C Exemplary Embodiment, wherein the first polymeric film has a thickness in a range from 25 to 125 (in some embodiments, in a range from 50 to 75) micrometers.

23C. The article of any preceding C Exemplary Embodiment, wherein the first layer has a thickness in a range from 0.05 to 0.5 (in some embodiments, in a range from 0.01 to 0.5) micrometer.

24C. The article of any preceding C Exemplary Embodiment, wherein the first release layer has a thickness of at least 0.02 (in some embodiments, in a range from 0.025 to 0.5, or even 0.05 to 0.5) micrometer.

25C. The article of any preceding C Exemplary Embodiment, wherein the first polymeric film is one of a polyester film or a polypropylene film.

26C. The article of any preceding C Exemplary Embodiment having a thickness in a range from 200 to 400 micrometers.

27C. The article of any preceding C Exemplary Embodiment, further comprising a second layer having first and second, opposed major surfaces on the second major surface of the first polymeric film.

28C. The article of Exemplary Embodiment 27C, wherein the second layer is provided by curing a composition comprising a blend of (a) a sulfonated polyester, (b) at least one of a self-crosslinking acrylic or a self-crosslinking polyurethane binder, and (c) melamine-formaldehyde crosslinker, wherein the uncured aqueous composition has a free-formaldehyde content not greater 0.04 (in some embodiments, not greater than 0.03, 0.025, 0.02, or even not greater than 0.01) part per million formaldehyde as determined by the Formaldehyde Test.

29C. The article of either Exemplary Embodiment 27C or 28C, further comprising a second release layer having first and second, opposed major surfaces on the second major surface of the second layer.

30C. The article of Exemplary Embodiment 29C, wherein the second release layer is a silicone release layer.

31C. The article of either Exemplary Embodiment 29C or 30C, further comprising a second optically clear adhesive layer having first and second, opposed major surfaces on the second major surface of the second release layer.

32C. The article of Exemplary Embodiment 31C, wherein the second optically clear adhesive layer comprises a (meth)acrylate copolymer having pendant (meth)acryloyl groups and optionally pendant hydroxyl groups (e.g., compounded with a free-radical generating initiator), wherein the (meth)acrylate copolymer has a weight average molecular weight of 50,000 to 600,000 Daltons and an average molecular weight between (meth)acryloyl groups equal to at least 16,000 Daltons.

33C. The article of any either Exemplary Embodiment 31C or 32C, wherein the second optically clear adhesive layer has a thickness in a range from 100 to 250 (in some embodiments, in a range from 125 to 200) micrometers.

34C. The article of either Exemplary Embodiment 32C or 33C, wherein if the second optically clear adhesive layer is peeled from the second release layer the second major surface of the second release layer exhibits a haze not greater than 10% (measured using a haze meter obtained under the trade designation “HAZE-GARD PLUS” from BYK-Gardner, Columbia, Md.).

35C. The article of any of Exemplary Embodiment 31C to 34C, wherein if the second optically clear adhesive layer is peeled from the second release layer the second major surface of the second release layer has a surface roughness, Rₐ, not greater than 0.15 (in some embodiments, not greater than 0.1, or even not greater than 0.05) micrometer (as described in the Examples).

36C. The article of any of Exemplary Embodiments 31C to 35C, further comprising a third polymeric film having first and second, opposed major surfaces on the second major surface of the second optically clear adhesive layer, wherein the article comprises in order, the first polymeric film, the first layer, the first release layer, the first optically clear layer, the second polymeric film, the second layer, the second release layer, the second optically clear adhesive, and the third polymeric film.

37C. The article of Exemplary Embodiment 36C, wherein the third polymeric film is one of a polyester film or polypropylene film.

38C. The article of any of Exemplary Embodiment 31C to 37C, wherein the third film has a thickness in a range from 25 to 125 (in some embodiments, in a range from 50 to 75) micrometers.

39C. The article of any of Exemplary Embodiment 31C to 38C, wherein the second layer has a thickness in a range from 0.05 to 0.5 (in some embodiments, in a range from 0.01 to 0.5) micrometer.

40C. The article of any of Exemplary Embodiment 30C to 39C, wherein the second release layer has a thickness of at least 0.02 (in some embodiments, in a range from 0.025 to 0.5, or even 0.05 to 0.5) micrometer.

41C. The article of any of Exemplary Embodiment 30C to 40C having a thickness in a range from 200 to 400 micrometers.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

Materials used in the Examples are listed in Table 1, below.

TABLE 1

| Material Name, | | |
|---|---|---|
| Acronym, or | | |
| Designation | Description | Source |
| SILQUEST | Glycidoxypropyltrimethoxy (epoxy functional) Silane, | Momentive |
| A-187 | obtained under the trade designation “SILQUEST A-187” | Performance Chemicals |
| | | Inc., Waterford, NY |
| CYMEL 327 | Melamine formaldehyde resin, obtained under the trade | Allnex USA Inc., |
| | designation “CYMEL 327” | Alpharetta, GA |
| CYCAT 4045 | Para toluene sulfonic acid catalyst, amine blocked, | Allnex USA Inc., |
| | obtained under the trade designation “CYCAT 4045” | Alpharetta, GA |
| EASTEK 1100 | Sulfonated polyester aqueous dispersion containing 33 | Eastman Chemical Co., |
| | wt. % polymer solids, obtained under the trade designation | Kingsport, TN |
| | “EASTEK 1100” | |
| DYNOL 607 | An ethoxyated acetylenic gemini surfactant, obtained | Evonik, Essen, |
| | under the trade designation “DYNOL 607” | Germany |
| TURBOSET | Self-crosslinking waterborne polyurethane composite | Lubrizol, Wickliffe, |
| 2027 | dispersion, obtained under the trade designation | OH |
| | “TURBOSET 2017” | |
| AC 2314 | Self-crosslinking polyacrylate (acrylic) dispersion, | Alberdingk Boley Inc. |
| | obtained under the trade designation | Greensboro, NC |
| | “ALBERDINGKUSA AC 2314” | |
| VTSP | A divinyl terminated silicone polymer with viscosity of | Dow Coming |
| | 250 to 400 cS, a vinyl content of 0.53 to 0.66 weight | Corporation, Midland, |
| | percent, and containing 150 ppm platinum, and 0.7 weight | MI |
| | percent inhibitor | |
| HFSX | A liquid, hydride functional polysiloxane crosslinker | Dow Coming |
| | component, 100% solids and having a viscosity at 25° C. | Corporation, Midland, |
| | of 30 cS, obtained under the trade designation “SYL-OFF | MI |
| | 7678 CROSSLINKER” | |

### Example 1

A coating solution was prepared as follows. A solution of 35.9 grams of water and 0.03 gram of surfactant (“DYNOL 607”) was continuously stirred. To that was added 6.9 grams of sulfonated polyester aqueous dispersion (“EASTEK 1100”), 5.7 grams of self-crosslinking polyurethane (“TURBOSET 2027”), 0.2 gram of epoxy functional silane (“SILQUEST A-187”), 2.5 grams of melamine formaldehyde crosslinker (“CYMEL 327”) (diluted to 20 wt.% solids with deionized (DI) water), and 0.3 gram of catalyst (“CYCAT 4045”) (diluted to 10 wt.% solids with DI water).

### Example 2

A coating solution was prepared as described in Example 1, except 4.6 grams of self-crosslinking polyacrylate (“AC 2314”) was used in place of the self-crosslinking polyurethane (“TURBOSET 2027”).

### Example 3

A coating solution was prepared as follows. A solution of 37.6 grams of water and 0.03 gram of surfactant (“DYNOL 607”) was continuously stirred. To that was added 7.4 grams of self-crosslinking polyurethane (“TURBOSET 2027”), 0.2 gram of epoxy functional silane (“SILQUEST A-187”), 2.5 grams of melamine formaldehyde crosslinker (“CYMEL 327”) (diluted to 20 wt. % solids with DI water), and 0.3 gram of catalyst (“CYCAT 4045”) (diluted to 10 wt. % solids with DI water).

### Example 4

A coating solution was prepared as follows. A solution of 33.9 gram of water and 0.03 gram of surfactant (“DYNOL 607”) was continuously stirred. To that was added 12.1 gram of sulfonated polyester aqueous dispersion (“EASTEK 1100”), 0.3 gram of epoxy functional silane (“SILQUEST A-187”), 2.7 gram of melamine formaldehyde crosslinker (“CYMEL 327”) (diluted to 20 wt. % solids with DI water), and 0.4 gram catalyst (“CYCAT 4045”) (diluted to 10 wt. % solids with DI water).

### Example 5

A coating solution was prepared as follows. A solution of 49.5 gram of water with 0.5 gram of melamine formaldehyde crosslinker (“CYMEL 327”) is continuously stirred.

### Coating Method

The coating solutions of Examples 1-4 were coated onto non-oriented, cast, 432 micrometer thick polyethylene terephthalate (PET) film made in-house by the usual extrusion techniques known to one of ordinary skill in the art using a coating rod (obtained under the trade designation “MAYER ROD, NO. 6” from RDS Specialties, Webster, NY). The coating of thickness ranged from 381-650 micrometers. The samples were dried in a lab batch electric oven (obtained under the trade designation “PROTOCOL PLUS” from Despatch Industries, Minneapolis, MN) set at 80° C. for 2 minutes. Samples were then loaded into a lab scale batch film stretching machine (obtained under the trade designation “KARO IV” from Bruckner-Maschinenbau GmbH & Co. KG, Siegsdorf, Germany). The samples were pre-heated at 98° C. for 50 seconds, then simultaneously stretched to 3.6 times the unstretched dimension in the transverse direction and 1.8 times the unstretched dimension in the machine direction, followed by heating for 15 seconds at 215° C.

Primer coated stretch-oriented polyester films were coated with a silicone release formulation which is a mixture of a divinyl terminated silicone polymer (“VTSP”), and a hydride functional polysiloxane crosslinker (“HFSX”). The divinyl terminated silicone polymer (“VTSP”)100 parts by wt.) and hydride functional polysiloxane crosslinker (“HFSX”) (2.54 parts by wt.) were mixed, yielding a hydride:vinyl ratio of 1.2:1, and the mixture was stirred to give a homogeneous solution. The silicone release formulation was coated onto the primed side of the test films made as described above, using a coating rod (obtained under the trade designation “MAYER ROD, NO. 5” from RDS Specialties, Webster, N.Y.), and was then dried in an oven (obtained under the trade name “PROTOCOL 3” from Despatch Industries, Minneapolis, Minn.) set at 120° C. for 2 minutes. Samples were then stored at 22° C. and in 50% humidity for at least seven days.

Onto the silicone coated films, coatings of adhesive were prepared as described in Example 1, col. 14 lines 35-60, of U.S. Pat. No. 8,911,873 B2 (Suwa et al.), the disclosure of which is incorporated herein by reference, except that the primed and silicone coated films of these Examples were used as substrate films instead of the L substrate films under the trade designation “CERAPEE”, the adhesive was notch bar coated to 130-170 micrometers thick, and the over-laminated release film was a plain, uncoated, biaxially oriented PET homopolymer film rather than the film under the trade designation “PUREX A-31. ” The laminated articles were stored for seven days at 22° C. and 50% relative humidity.

### TEST METHODS

### Formaldehyde Test

The formaldehyde measurement was made with a formaldehyde meter (obtained under the trade designation “RIKEN FP-31(EX)” from Riken Keiki Co., Ltd., Tokyo, Japan). Within the first 60 minutes of preparing the solution in the Examples, the meter was held about 0-2 cm over a continuously stirring beaker of the composition to be tested at room temperature (20-24 ° C.). The measurement was made using the No.008 tab for 1800 seconds (30 minutes) at 40-60% relative humidity.

### Liner Peel Procedure and Visual Whitening Test

Although not wanting to be bound by theory, it is believed that in commercial use as a delivery system for adhesives, the laminated articles made above would have the non-exemplary release film peeled off, the exposed adhesive would be applied to a surface such as an optical display part, and the Exemplary liner would then be peeled off, leaving the adhesive on the optical display part. To simulate this process, so as to be able to measure the haze and degree of whitening in commercial use of the exemplary liners of Examples 1-4, a controlled 180-degree peel was performed on the laminated articles. A peel tester (obtained under the trade designation “SP 2100” from Imass, Accord, Mass.) equipped with a 5.0 lbs. (2.27 kg) load cell was operated with the following parameters: a 1 inch (2.54 cm) wide test specimen, a peel rate of 90 in./min. (229 cm/min.), a one second delay before data acquisition, and a five second averaging time. The load cell was tared before starting a peel. Double sided masking tape (obtained under the trade designation “3M 410M,” 3M Company, St. Paul, Minn.) was used to adhere a sample made above, with the silicone liner side up, to platen, and the primed silicone liner was attached to the peel arm. Then the platen was “Jogged” until the liner was taut and then the peel was begun.

Visual appearance was rated for whitening based on a visual rating scale from 1 to 3, where a 1 represented significant whitening, a 2 represented slight whitening, and a 3 represented no whitening. The most desirable rating is the 3 rating (i.e., no whitening of the liner after its peeling-mode removal from the PSA).

Test results for the visual whitening of Examples 1-5 are shown in Table 2, below.

TABLE 2

| | | Haze | Surface | |
|---|---|---|---|---|
| | | Measurement | Roughness | Visual |
| Example | Formaldehyde | Test, | Ra, | Whitening |
| No. | Test, ppm | % Haze | (micrometers | Rating |
| 1 | <0.01 | 0.82 | 0.019 | 3 |
| 2 | <0.01 | 1.34 | 0.021 | 3 |
| 3 | <0.01 | 0.81 | 0.121 | 2 |
| 4 | 0.04 | — | — | 1 |
| 5 | 0.05 | — | — | — |

### Haze Measurement Test

Haze measurements were made on the silicone liner peeled from the adhesive with a haze meter (obtained under the trade designation “HAZE-GARD PLUS” from BYK-Gardner, Columbia, Md.). After pressing “Operate,” the sample was held to the Haze-port, “Operate” was pressed again, sample was then held to the Clarity-port and “Operate” was pressed a third time. Haze values (% Haze) were recorded from the display. The values reported an average of 2-3 readings, in Table 2, above.

### Surface Roughness Test

Using a 3D laser scanning microscope (obtained under the trade designation “VK-X200” from Keyence, Osaka, Japan), as a surface roughness evaluator, a sample was focused at 150x in “Laser” mode. The brightness was adjusted to just below the level where the pixels were maxed out and the settings selected are “Surface Profile” mode, “Standard” area, and “High Accuracy” quality. The RPD box was clicked and the measurement taken. In the MultiFileAnalyzer window, “Process Image”, then “Reference Plane settings”, then “Specify Area” were clicked, and the background was matched and subtracted. “Surface R”, then “Add an area . . . ” were clicked and the area was selected. The surface roughness recorded was the Ra value. The results are listed Table 2, above.

Foreseeable modifications and alterations of this disclosure will be apparent to those skilled in the art without departing from the scope and spirit of this invention. This invention should not be restricted to the embodiments that are set forth in this application for illustrative purposes.

1. An uncured aqueous composition comprising a blend of (a) a sulfonated polyester, (b) at least one of a self-crosslinking acrylic or a self-crosslinking polyurethane binder, and (c) melamine-formaldehyde crosslinker, wherein the uncured aqueous composition has a free-formaldehyde content not greater than 0.04 part per million formaldehyde as determined by the Formaldehyde Test.

2. The uncured aqueous composition of claim 1, wherein the sulfonated polyester comprises an oxyalkylene (OR) having a carbon chain length of at least 2 carbon atoms.

3. The uncured aqueous composition of claim 1, wherein the sulfonated polyester has a glass transition temperature not greater than 75° C.

4. The uncured aqueous composition of claim 1, wherein the sulfonated polyester has the formula: 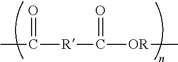
wherein n is at least 10, and wherein at least some R′ comprise arylenesulfonate.

5. The uncured aqueous composition of claim 4, wherein the arylenesulfonate comprises at least one of a phenylenesulfonate, an isophthalylene-5-sulfonate, a terephthalylene-sulfonate, or a phthalylene-sulfonate.

6. The uncured aqueous composition of claim 4, the arylenesulfonate comprises at least one of lithium arylenesulfonate, sodium arylenesulfonate, potassium arylenesulfonate, calcium arylenesulfonate, beryllium arylenesulfonate, a zinc arylenesulfonate, a zirconium arylenesulfonate, a vanadium arylenesulfonate, copper arylenesulfonate, or aluminum arylenesulfonate.

7. The uncured aqueous composition of claim 1, wherein the sulfonated polyester is present in a range from 10 to 70 weight percent, based the total solid content of the uncured aqueous composition.

8. The uncured aqueous composition of claim 1, wherein the self-crosslinking acrylic is present and contains both carbonyl and hydrazone functional group that can react and crosslink with each other.

9. The uncured aqueous composition of claim 1, wherein the self-crosslinking acrylic is present in a range from 10 to 80 weight percent, based the total solid content of the uncured aqueous composition.

10. The uncured aqueous composition of claim 1, wherein the self-crosslinking polyurethane is present and contains both carbonyl and hydrazone functional group that can react and crosslink with each other.

11. The uncured aqueous composition of claim 1, wherein the self-crosslinking polyurethane binder is present in a range from 10 to 80 weight percent, based the total solid content of the uncured aqueous composition.

12. The uncured aqueous composition of claim 1, wherein the melamine-formaldehyde crosslinker comprises a partially alkoxymethylated melamine formaldehyde resin.

13. The uncured aqueous composition of claim 1, wherein the melamine-formaldehyde crosslinker is present in a range from 1 to 15 weight percent, based the total solid content of the uncured aqueous composition.

14. The uncured aqueous composition of claim 1 that is cured.

15. An article comprising, in order:
a first polymeric film having first and second, opposed major surfaces,
a first layer having first and second, opposed major surfaces, the first layer comprises the cured composition of claim 14; and
a first release layer having first and second, opposed major surfaces.
